(19) United States
(12) Patent Application Publication
(10) Pub. No.: US 2004/0071311 A1
(43) Pub. Date: Apr. 15, 2004

(54) Network camera apparatus, network camera server and digital video recorder for preventing forgery and alteration of a digital image, and apparatus for authenticating the digital image from said apparatus, and method thereof

(76) Inventors: Jong-Uk Choi, Seoul (KR); Young-Ho Choi, Incheon (KR); Dong-Hwan Shin, Seoul (KR); Ji-Sun Seo, Seoul (KR)

Correspondence Address: Blakely Sokoloff Taylor & Zafman, Seventh Floor, 12400 Wilshire Boulevard, Los Angeles, CA, 90025-1026, US

(21) Appl. No.: 10/450,234

(22) PCT Filed: Dec. 10, 2001
(86) PCT No.: PCT/KR01/02135

(30) Foreign Application Priority Data
Dec. 9, 2000 (KR) 2000-74963
Oct. 12, 2001 (KR) 2001-62934

(51) Int. Cl. G06K 9/00

(52) U.S. Cl. 382/100

(57) ABSTRACT

The present invention discloses a network camera apparatus, network camera server and digital video recorder which makes it possible to prevent a digital image from being forged or altered by embedding a watermark into an image signal input through a camera in a real time. Two types of watermark, i.e. a robust watermark for authenticating whether the image is original image or not and a fragile watermark whether the image is forged or altered or where the forgery or alteration of image takes place. An authentication apparatus for authenticating the watermark-embedded image is further disclosed.

### FIELD OF THE INVENTION

The present invention relates to a network camera apparatus, network camera server, and digital video recorder capable of preventing a digital image from being forged or altered by embedding a robust watermark and fragile watermark into the image inputted through a camera in real time, and relates to an apparatus for determining whether the image is the original or not and the image has been forged or altered and the method thereof.

### DESCRIPTION OF THE RELATED ART

Such a camera that photographs and transmits an image and its related apparatus are mainly used in a security system. At present, the representative systems which receive an image through a camera and transmit the image and show the displayed image are (i) a general closed circuit camera (CCTV) system, (ii) a digital CCTV system (DVR: Digital Video Recorder), (iii) a network camera (web camera) system, and (iv) a system employing USB camera.

Such image transmitting cameras make a general person (or authorized person) possible to see the image by transmitting a photographed image and using a web browser and monitor, etc. at a short-distance or remote place. A network camera among these cameras generally includes a web server function in a general monitor camera and thus is called a “web camera” or “Internet camera”.

A network camera server, another type of the network camera, receives an image signal from a plurality of cameras comprising a lens and image sensor and each being separated in a place outside and converts it to one united image signal to transmit it through network, and performs a network server function for the image signal photographed by a plurality of cameras.

The above stated network camera or network camera server has its own unique IP and has a function of transmitting the obtained image signal through network at high speed of the minimum 10 frames to the maximum 30 frames per second in a compression method of JPEG or M-JPEG, Wavelet compression method, or MPEG compression method using a standard web browser without an additional PC.

Meanwhile, a DVR, a digital CCTV system, is largely used as a next-generation monitoring system substituting for a monitoring system comprising the existing CCD camera, VCR, and TAPE, etc. While a monitoring system of an analog type monitors environment for which monitoring is sought and records the necessary image data in a TAPE to search and store, a DVR converts the photographed image signal to a digital signal and stores it in a hard disk or DVD-RAM. Hence, it could be said that a DVR has various advantages over analog equipment. Further, one DVR can record and manage a plurality of cameras (e.g., 16 cameras) and a plurality of images (16 divisional image).

For reference, “network” mentioned in the present invention include all connecting methods of network generally known such as ISDN, connection by an exclusive line, connection by LAN, connection by a telephone network (PSTN, PSDN), connection by WAN, further particularly connection by Internet, remote image search using TCP/IP (protocol), etc.

However, it is a tendency that an image signal which has been photographed after an object is recognized by cameras is photographed using a digital camera apparatus owing to the recently fast development of a digital image technology like a DVR. As stated above, the recently fast development of a digital image technology enables a DVR to store the photographed image in a digital format. Users also tend to employ a digital image for a variety of processing. In case of an analog image, the analog image is digitalized employing an A/D converter.

However, following such digitalization current, users can operate a digital image photographed by a general image editor, as they want. Hence, there occurs a problem that using the above network cameras or DVR as a monitoring camera requiring an image be identical to the original image primarily photographed has a restriction.

In other words, a problem comes up that it is very easy to forge and alter and edit a digital image due to characteristics of a digital image. Therefore, a way to confirm that the photographed and transmitted image has an effect for evidence and is the original image becomes an issue.

In addition, it is required for a digital image to have a legal effect by authenticating the original of a digital image and accurately detecting the location of the forged and altered image in a case where an image is forged or altered.

### SUMMARY OF THE INVENTION

The present invention is to solve the problems described above. Therefore, it is an object of the present invention to provide a network camera, network camera server, and digital video recorder having a function of embedding a watermark, thereby particularly preventing an illegal fabrication action of the image photographed for monitoring and simultaneously detecting the fact that the image is illegally modified when such image for monitoring is modified.

It is another object of the present invention to embed a robust watermark and also fragile watermark into an image being photographed, thereby authenticating whether an image is the original or not by an information regarding an image operator and the image itself as well as whether an image is forged or altered and the position where the forgery or alteration occurred.

In order to achieve the above object, the present invention provides a network camera apparatus comprising an image inputting portion for receiving an image signal which is photographed in real time; an image data processing portion for converting the image signal outputted from image inputting portion to a digital signal; an information generating portion for generating an information to be embedded as watermark; a watermark generating portion for generating the watermark using the information of information generating portion; a first watermark embedding portion for embedding a first watermark generated at watermark generating portion into the image signal outputted from image data processing portion; an image compressing portion for compressing the first watermark-embedded image signal outputted from first watermark embedding portion; a second watermark embedding portion for embedding a second watermark generated at watermark generating portion into the compressed image signal outputted from image compressing portion; and a network connecting portion for transmitting the second watermark-embedded image signal outputted from second watermark embedding portion through a network.

In the network camera apparatus, it is preferable that the information generating portion includes a determined information generating portion for generating the determined information stored in network camera apparatus and an arbitrary information generating portion for generating an information transmitted from a distant place through network, and it is also preferable that the first watermark which is embedded into the image signal at the first watermark embedding portion is a robust watermark and the second watermark which is embedded into the image signal at the second watermark embedding portion is a fragile watermark.

Further, it is preferable that the network camera apparatus further comprises a real-time operating portion for controlling the embedding of a watermark, compression of the image signal, and generation of the arbitrary information in real time.

In order to achieve another object of the present invention, the present invention provides an apparatus for authenticating a watermark-embedded image transmitted from the network camera apparatus, comprising an image inputting portion receiving a watermark-embedded and compressed image signal through a network; an image decompressing portion for restoring the image signal outputted from image inputting portion to the image signal prior to compression; an image authenticating portion for determining whether the image to be authentic by calculating correlation between a watermark extracted from the digital image which is restored at image decompressing portion and a watermark generated from an information for authentication of an image; and an image authentication result output portion for outputting a authentication result of image authenticating portion.

It is preferable that the image authenticating portion comprises a robust watermark authenticating portion for detecting a robust watermark, thereby determining whether the image is an original and a fragile watermark authenticating portion for detecting a fragile watermark, thereby determining whether the image has been forged/altered and finding the position where a forgery/alteration has been occurred.

In order to achieve still another object of the present invention, the present invention provides a method for embedding watermark into an image signal photographed through a network camera apparatus and transmitting the image signal to a network, said method comprising the steps of converting an image signal inputted in real time to a digital signal; embedding a robust watermark containing an unique information of the network camera apparatus into the converted image signal; compressing the robust watermark-embedded image signal; embedding a fragile watermark containing an arbitrary information transmitted from a distant place through network into the compressed image signal; and transmitting the watermark-embedded image signal through a network.

In order to achieve still another object of the present invention, the present invention provides a network camera server comprising a plurality of image data processing portions for converting each of image signals inputted from a plurality of cameras in real time to a digital signal; an information generating portion for generating an information to be embedded as watermark, said information corresponding to each of image signals; a watermark generating portion for generating each of watermarks corresponding to each of the image signals using the information of said information generating portion; a plurality of watermark embedding portions for embedding respectively the watermark generated at said watermark generating portion into each of image signals outputted from said plurality of image data processing portions; an image compressing portion for compressing respectively the watermark-embedded image signals outputted from said plurality of watermark embedding portions; an image signal combining portion for combining the plurality of image signals outputted from said image compressing portion into a single image signal; and a network connecting portion for transmitting the combined image signal outputted from said image signal combining portion through a network.

In order to achieve still another object of the present invention, the present invention provides an apparatus for authenticating a watermark-embedded image transmitted from the network camera server comprising an image inputting portion receiving a watermark-embedded, compressed and combined image signal through a network; an image signal dividing portion for dividing the combined image signal outputted from said image inputting portion into an image signal corresponding each of cameras; a plurality of image storing portion for storing respectively the image signal divided into at said image signal dividing portion; an image signal selecting portion for selecting a image signal which needs to be authenticated among the image signals stored in said image storing portions; an image decompressing portion for restoring the image signal selected at said image signal selecting portion to the image signal prior to compression; an image authenticating portion for determining whether the image to be authentic by calculating correlation between a watermark extracted from the digital image which is restored at said image decompressing portion and a watermark generated from an information for authentication of an image; and an image authentication result output portion for outputting a authentication result of said image authenticating portion.

In order to achieve still another object of the present invention, the present invention provides a method for embedding watermark into a plurality of image signals inputted from a plurality of cameras and transmitting the image signals to a network, said method comprising the steps of converting said plurality of image signals inputted from said plurality of cameras in real time to digital signals, embedding a robust watermark containing an unique information of the plurality of cameras or the network camera server into each of the converted image signals in real time, compressing the robust watermark-embedded image signals respectively, embedding a fragile watermark containing an arbitrary information transmitted through network into the each of the compressed image signals in real time, combining the plurality of the fragile watermark-embedded image signals into a single image signal; and transmitting the combined image signal through a network.

In order to achieve still another object of the present invention, the present invention provides a digital video recorder which comprises a watermark embedding apparatus for embedding watermark into a plurality of image signals inputted from a plurality of cameras, said watermark embedding apparatus comprising a plurality of image data processing portions for converting each of image signals inputted from a plurality of cameras in real time to a digital signal, an information generating portion for generating an information to be embedded as watermark, said information corresponding to each of image signals, a watermark generating portion for generating each of watermarks corresponding to each of the image signals using the information of said information generating portion, a plurality of a first watermark embedding portions for embedding respectively a first watermark generated at said watermark generating portion into each of image signals outputted from said plurality of image data processing portions, and an image signal combining portion for combining the plurality of watermark-embedded image signals outputted from said plurality of the first watermark embedding portion into a single image signal, wherein the image signal outputted from said image compressing portion is compressed and then recorded.

It is preferable that the watermark embedding apparatus further comprises a plurality of a second watermark embedding portions for embedding respectively a second watermark generated at said watermark generating portion into each of image signals outputted from said plurality of the first watermark embedding portion.

It is preferable that the watermark embedding apparatus is integrated into said digital video recorder as hardware or as a software module.

In order to achieve still another object of the present invention, the present invention provides an apparatus for authenticating a watermark-embedded image from the digital video recorder comprising an image inputting portion for receiving a watermark-embedded and combined image signal as a transmission through a network or a file format, an image signal dividing portion for dividing for dividing the combined image signal outputted from said image inputting portion into an image signal corresponding each of cameras, an image authenticating portion for determining whether the image to be authentic by calculating correlation between a watermark extracted from the digital image from said image signal dividing portion and a watermark generated from an information for authentication of an image, and an image authentication result output portion for outputting a authentication result of said image authenticating portion.

In order to achieve still another object of the present invention, the present invention provides a method for embedding watermark into a plurality of image signals inputted from a plurality of cameras and recording the image signals, said method comprising the steps of converting said plurality of image signals inputted from said plurality of cameras in real time to digital signals, embedding a robust watermark containing an unique information of the plurality of cameras into each of the converted image signals in real time, embedding a fragile watermark containing an arbitrary information transmitted through network into each of the robust watermark-embedded image signals in real time, combining the plurality of the fragile watermark-embedded image signals into a single image signal, and compressing the combined image signal and then recording the image signal.

In order to achieve still another object of the present invention, the present invention provides a digital video recorder for recording a plurality of image signals inputted from a plurality of cameras, wherein a plurality of watermark embedding apparatus are respectively installed in said plurality of cameras in a separate manner, and each of the watermark embedding apparatus comprises an image data processing portion for converting the image signal inputted from corresponding camera in real time to a digital signal, an information generating portion for generating an information to be embedded as watermark, a watermark generating portion for generating the watermark using the information of said information generating portion, and a first watermark embedding portion for embedding a first watermark generated at said watermark generating portion into the image signal outputted from said image data processing portion, wherein the image signal outputted from said first watermark embedding portion is compressed and then recorded.

It is preferable that each of the watermark embedding apparatus further comprises a second watermark embedding portion for embedding a second watermark generated at said watermark generating portion into the image signal outputted from said first watermark embedding portion.

In order to achieve still another object of the present invention, the present invention provides an apparatus for authenticating a watermark-embedded image from the digital video recorder comprising an image inputting portion for receiving an image signal as a transmission through a network or a file format, an image authenticating portion for determining whether the image to be authentic by calculating correlation between a watermark extracted from the digital image outputted from said image inputting portion and a watermark generated from an information for authentication of an image, and an image authentication result output portion for outputting a authentication result of said image authenticating portion.

### BRIEF DESCRIPTION OF THE DRAWINGS

FIG. 1 is a block diagram illustrating the constitution of a network camera apparatus which embeds a robust watermark and fragile watermark into an image inputted and transmits it through network according to a first embodiment of the present invention.

FIG. 2A is a block diagram illustrating the constitution of an apparatus of authenticating the original of the image transmitted through network from a network camera apparatus of FIG. 1 and whether the image is forged/altered or not.

FIG. 2B is a flow chart illustrating a process of extracting a robust watermark from the apparatus of FIG. 2A and authenticating whether the image is original or not.

FIG. 2C is a flow chart illustrating a process of extracting a fragile watermark from the apparatus of FIG. 2A and authenticating whether the image is forged/altered or not.

FIG. 3 is a block diagram illustrating the constitution of a network camera server which embeds a robust watermark and fragile watermark into a plurality of images outputted from a plurality of image inputting apparatus and transmits it through network according to a second embodiment of the present invention.

FIG. 4 is a block diagram illustrating the constitution of an apparatus of authenticating the original of an image transmitted through network from a network camera server of FIG. 3 and whether the image is forged/altered or not.

FIG. 5A is a block diagram illustrating the constitution of a watermark embedding apparatus which embeds a robust watermark and fragile watermark into a plurality of image inputted from a plurality of image inputting apparatus and a digital video recorder which is connected to the watermark embedding apparatus to record and store a watermark-embedded image according to a third embodiment of the present invention.

FIG. 5B is a block diagram illustrating the constitution of a watermark embedding apparatus which embeds a robust watermark and fragile watermark into a plurality of image inputted from a plurality of image inputting apparatus and a digital video recorder which is connected to said watermark embedding apparatus to record and store a watermark-embedded image according to a modification of a third embodiment of the present invention.

FIG. 6 is a block diagram illustrating the constitution of an apparatus of authenticating the original of an image outputted from the digital video recorder of FIG. 5A and FIG. 5B and whether the image is forged/altered or not.

FIG. 7A is a block diagram illustrating the constitution of a watermark embedding apparatus which is connected to each of a plurality of image inputting apparatus separately and a digital video recorder which is connected to said watermark embedding apparatus to record and store a watermark-embedded image according to a fourth embodiment of the present invention.

FIG. 7B is a block diagram illustrating a detailed constitution of the watermark embedding apparatus of FIG. 7A.

FIG. 8 is a block diagram illustrating the constitution of an apparatus of authenticating the original of an image outputted from the digital video recorder of FIG. 7A and whether the image is forged/altered or not.

### DETAILED DESCRIPTION OF THE PREFERRED EMBODIMENTS

Hereinbelow, preferred embodiments of the present invention referring to the attached figures are explained in detail.

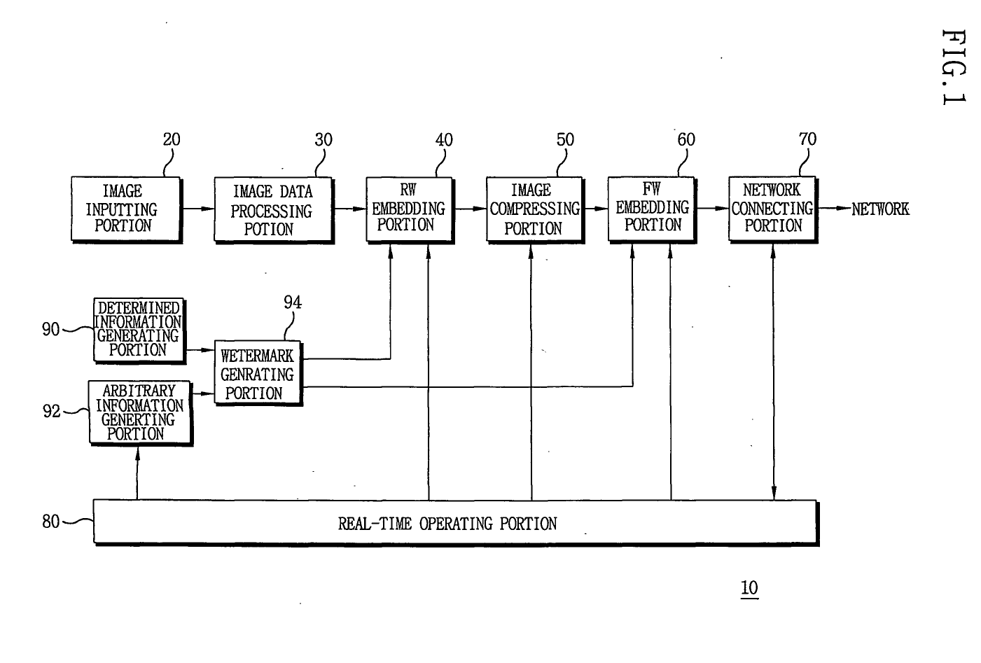

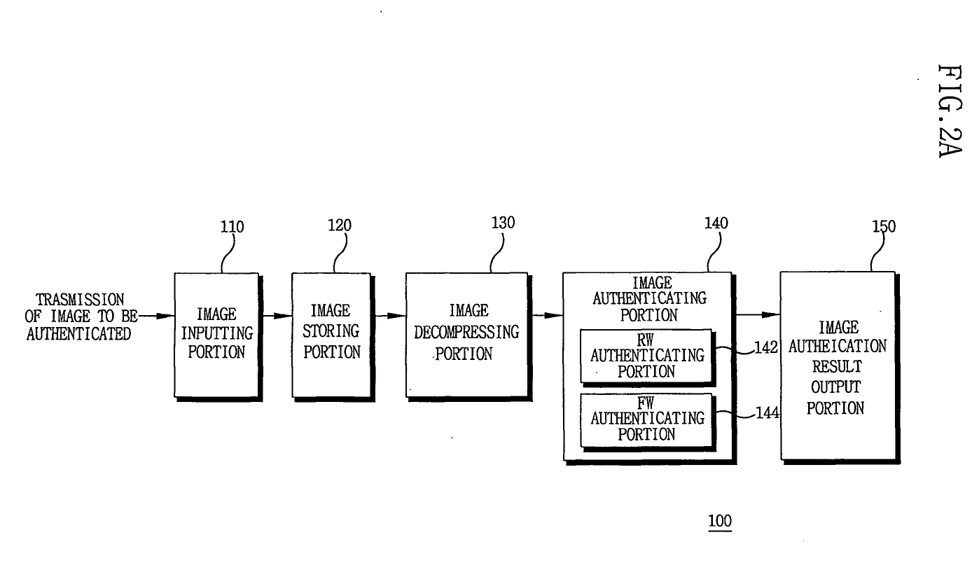

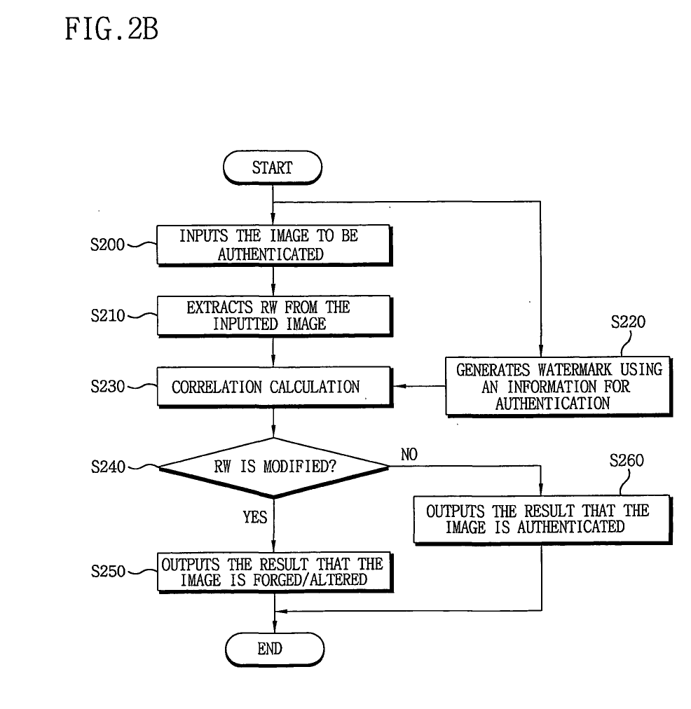

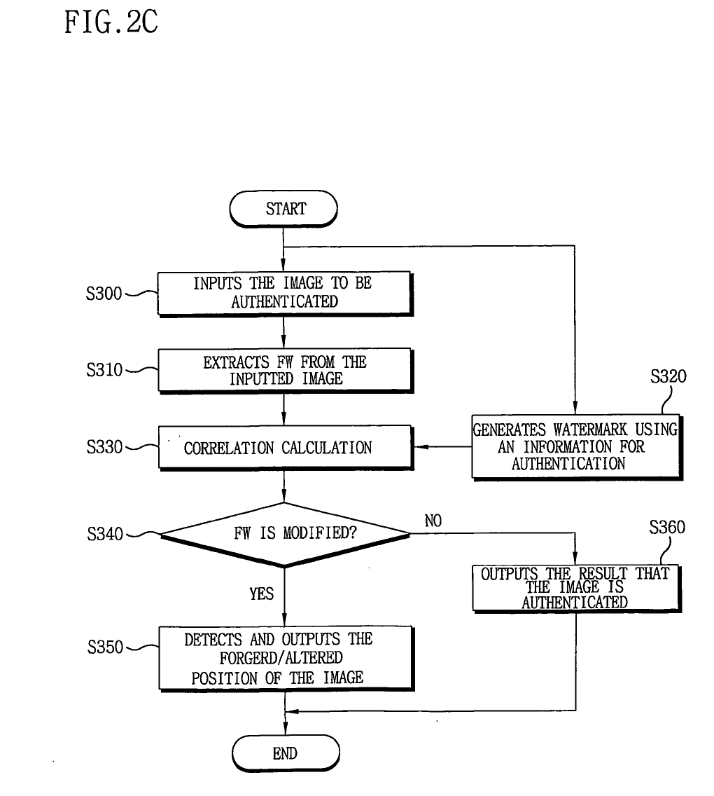

First, referring to FIGS. 1 and 2, an embodiment wherein the technology of repeatedly embedding a watermark according to the present invention is applied to a network camera apparatus is explained.

FIG. 1 is a block diagram illustrating the constitution of a network camera apparatus 10 which embeds a robust watermark and fragile watermark into an inputted image to transmit it through network according to a first embodiment of the present invention.

Referring to FIG. 1, the network camera apparatus 10 according to a first embodiment of the present invention comprises an image inputting portion 20, an image data processing portion 30, a determined information generating portion 90, an arbitrary information generating portion 92, a watermark generating portion 94, a robust watermark embedding portion 40 (hereinafter referred to as “RW (Robust Watermark)”), a fragile watermark embedding portion 60 (hereinafter referred to as “FW (Fragile Watermark)”), an image compressing portion 50, a network connecting portion 70, and a real-time operating portion 80. Such components are included in a single apparatus of a network camera apparatus 10 as a hardware or software.

The image inputting portion 20 indicates a lens and image sensor and the like and the network camera apparatus 10 receives (i.e., photographs) an image signal in real time through the above image inputting portion. The image data processing portion 30 amplifies and corrects the image signal outputted from the image inputting portion 20 to be appropriate for its processing and then converts the image signal to a digital signal.

The determined information generating portion 90 generates an information to be embed on the basis of data stored in the network camera apparatus 10, and the arbitrary information generating portion 92 generates an information to be embedded on the basis of data transmitted from a distant place through network.

In other words, the determined information generating portion 90 generates the watermark embedding information such as a serial number and an unique image of a network camera which are determined and stored in a network camera apparatus itself. The arbitrary information generating portion 92 generates a key generating information or an unique image generating information transmitted from a distant place. If an operator inputs information to be embedded through an exclusive browser at a distant place, the real-time operating portion 80 makes a control signal and provides it to the arbitrary information generating portion 92, thereby performing the process according to instructions of the operator.

The above determined information or arbitrary information can be generated in the form of a key or image or in a method of simultaneously employing both key and image.

In the embodiment of the present invention, both determined information generating portion 90 and arbitrary information generating portion 92 are employed. However, it is also possible to use any one of the determined information generating portion 90 and arbitrary information generating portion 92 as occasion demands.

The watermark generating portion 94 generates a watermark using the information prepared in the determined information generating portion 90 and the arbitrary information generating portion 92. In the embodiment of the present invention, it is mainly explained that the watermark is generated by a key generating method (hereinafter referred to as “key watermark”) or by an image watermark generating method employing Discrete Wavelet Transform or Discrete Cosine Transform. However, it goes without saying that a method of generating a watermark which is embedded into an image and embedding the same, which is not restricted thereto, can be performed using any conventional optional watermarking technology.

First, key watermark embedding method is to generate a watermark signal to be generated by relying on a key generating method according to a pattern. The generated watermark signal is embedded and extracted in the form of a certain pattern, and a pseudo random number generating function involves in generating such pattern.

In other words, it can be said that the key watermark method is to embed a watermark in the form of a pseudo random number generated from a determined key value. To be more specific, if a random number generated from a key is Rc, the Rc becomes a binary code from. And, it is generally Rc∈{1,−1,} and appears in the form of like (1, 1, −1, −1, 1, −1, 1, −1 . . . ). The reason why the generated binary code does not consist of 1 and 0 but 1 and −1 is that in case a binary code consists of only 1 and 0, when Rc is added to image data as a watermark, the value of 1 and 0 gives a result of increasing the energy continuously.

However, in case a binary code consists of 1 and −1, it is possible for their addition to make the energy value unchanged. It is general for a code consisting of 1 and −1 to form a normal distribution wherein the mean is 0 and the variance is 1. It can be said that the “key” generating a watermark herein is an information to be a key necessary for embedding and extracting a watermark just as it is. The “key” can be employed as a key having a serial number assigned to each of network cameras (determined information) or can employ information transmitted through network from a distant place (arbitrary information), and can employ both the above two.

Next, an image watermark embedding method, which embeds image information itself as a watermark, could be a method of embedding a digital image itself like a user's own unique signature or company logo into an image as a watermark. Likewise a key watermark, an image watermark has a method of using a unique image data stored in a network camera (determined information) or an image data transmitted through network from a distant place (arbitrary information), and a method of using both the above two as an image information embedded as a watermark.

As stated above, a watermarking technology mainly employed for performing the present invention can be applied to all the watermarking technology already suggested or published. From this, there is a spatial domain method wherein the information to be embedded by analyzing data such as image in view of a space is scattered in space so as not to be easily distinguished. For example, there is a patchwork method wherein in n pairs of (ai, bi) optionally selected from the image, the value of light and darkness is added to ai one by one and the value of light and darkness is subtracted from bi one by one so that a digital watermark is embedded into space. Further, there is a method suggested by Pitas and Kaskalis in order to improve defect of the above patchwork method which deteriorate quality of the image visible to the naked eye. The method is that the image is divided into two subsets having the same size and a positive number, K-factor, which is calculated by a variance of the two subsets, is added to a pixel in one subset. Further, in order to complement the defect of the above Pitas and Kaskalis method that it is impossible to apply to a color image having much lots of data, there is Caronni method that the image is separated into N blocks and a bit stream is embedded into the value of luminance of each image block in order to minimize the calculation amount of a pixel unit, in case the average value of pixel in the block is bigger than the critical value, it is encoded as ‘1’ and in case smaller, it is encoded as ‘0’.

Further, there is a wide-band spread spectrum method in the spatial domain wherein all the pixels of the image are basically divided in the form of A, B, C set by the condition of |A|=|B|, and these sets are made of pseudo-random number generator and secret key value. If gray level of matrix A are increased by k in a gray color, to the contrary matrix coefficients of B are decreased. Thus the value of matrix C is not changed. That is, since matrixes A and B basically have the same distribution, the average value of making the image serial remains unchanged, and regarding perception of a watermark, two image coefficient sets A and B for the gray level of a gray image become identical to each other. Further, if it is possible to, separate A′=A and B′=B by k, such enables to apply to a method of perceiving a watermark.

As a frequency domain method of converting a multimedia data into an analog signal of frequency component and converting a watermark to be embedded into an analog signal in the same manner to embed, a method of generating a watermark by employing Discrete Cosine Transform, High-speed Fourier Transform, and Discrete Wavelet Transform can be applied.

The watermark generated by the above key generating method and/or image method is embedded into the obtained digital image. A method of embedding a watermark is classified into a robust watermark method (RW-method) and a fragile watermark method (FW-method) according to the intensity of embedding watermark.

In other words, both key watermark and image watermark are classified into a RW method that survives an external attack and a FW method that is broken by a very minute attack according to the intensity of embedding watermark, wherein both key generating method and image method are possible in a robust or fragile watermark in view of the technical algorithm.

To be brief, a robust watermark is embedded to make its extraction possible without being damaged even after passing through a variety of image processing of an external modification of the image, i.e., compression or filtering, and can be compared to stamping an unseen seal in a thick and strong manner so as not to be erased by any fabrication of an image.

Whereas, a fragile watermark is that a watermark signal is fragily embedded so that the embedded watermark can be broken by a very minute modification of an image and processing thereof. The fragile watermark can determine whether an image is fabricated or modified according to whether a watermark is damaged or not, and thus can be used as a method of perceiving and detecting the forgery/alternation of the image.

In summary, in the embodiment of the present invention, a key watermark or image watermark is generated and the generated watermark is embedded into an image in an RW-method and FW-method by steps. The key watermark and image watermark can be employed independently according to the purpose and simultaneously together by various combinations. The RW-method and FW-method can be performed independently and simultaneously together according to the purpose.

The embodiment mainly explained in the present invention employs the FW-method that can perceive the forgery/alternation of an image in embedding a watermark and additionally employs the RW-method together with the FW-method. That is, in the above embodiment, an important data to be extracted and confirmed in the future is embedded in the RW-method and a fragile watermark is embedded together in the purpose of preventing an image from being forged/altered.

In RW embedding portion 40, a first watermark generated in the watermark generating portion 94 is embedded into a digital image signal outputted from the image data processing portion 30 as a robust watermark. The first watermark should be robustly embedded so that information which is embedded into a watermark can be survived any external attacks. The RW-method is in detail described in Korean Patent Application Nos. 2000-53755, 1998-37273, and 1998-37274 which were filed in the same applicant as that of the present invention.

First, embedding a key watermark into a digital image signal as a robust watermark is in detail disclosed in Korean Patent Application No. 2000-53755 which was filed in the same applicant as that of the present invention. In the above patent application, a key watermark is embedded in the RW-method wherein even if a watermark-embedded image passes through an image modification like a dithering or halftone, the embedded watermark can be detected in a good manner and the watermark can be detected without the original image. Hence, it is appropriate for applying to a network camera requiring a watermark that survives any external attack while requiring fast embedding and fast detection.

Next, a detailed method regarding a process of embedding an image watermark such as an operator's specific logo into a digital image signal as a robust watermark is explained using technology disclosed in the above patent applications. Of course, it is not restricted thereto.

This method, when embedding an image watermark into an image, employs a discrete wavelet transform (DWT) and discrete cosine transform (DCT). In particular, this method can provide a watermarking method which is not damaged in JPEG and MPEG mainly used in the image compression. Both color image and gray image are possible. This is in detail explained in Korean Patent Application Nos. 1998-37273 and 1998-37274 which were filed in the same applicant as that of the present invention.

The above algorithms of embedding watermark are implemented in a single chip and can be installed in the network camera apparatus 10.

In the image compressing portion 50, a compressing process corresponding to each compression method of JPEG, Wavelet, and MPEG is proceeded so that a digital image signal into which a robust watermark outputted from the RW embedding portion 40 is embedded can be transmitted through network.

In FW embedding portion 60, a second watermark generated from the watermark generating portion 94 is embedded into a digital image signal compressed in the image compressing portion 50 as a fragile watermark. This is to appropriately regulate the pixel value of the original image in a spatial domain and embed a watermark within the regulated image data, thereby accurately detecting the location of the forged/altered data in the original image. This is in detail disclosed in Korean Patent Application No. 2000-64767 which was filed in the same applicant as that of the present invention.

The above watermark embedding can be optionally set and determined according to an operator's selection, use or level of image security. Like the preferred embodiment of the present invention, both RW embedding portion 40 and FW embedding portion 6 can be employed, and also any one of these portions can be employed.

In the network connecting portion 70, a fragile watermark-embedded digital image signal in the FW embedding portion 60 is transmitted through network and information which is transmitted through network from a distant place and will be generated in the optional information generating portion 132 is transmitted to the real-time operating portion 80.

The real-time operating portion 80 controls the above watermark processing in real time. The reason why such real-time control is necessary is that the image inputted and processed is 10 frames to 30 frames per second. The real-time operating portion 80 controls image signal to be compressed corresponding to each compressing method of JPEG, Wavelet, and MPEG in the image compressing portion 50 so as to transmit a watermark-embedded digital image through network, and controls information which is transmitted from network through the network connecting portion 70 and will be embedded as a watermark and transmits it to the arbitrary information generating portion 92.

The operation of the network camera apparatus 10 of the present invention explained above is as follows.

The image signal received through the image inputting portion 20 comprising lens and image sensor is amplified, corrected so as to be suitable for the processing and converted into a digital signal in the image data processing portion 30, and the signal is sent to the RW embedding portion 40.

Meanwhile, the determined information generating portion 90 generates a determined information which is stored in a network camera such as camera serial number or unique image to be embedded as a watermark. The arbitrary information generating portion 92 generates an arbitrary information when information to be embedded is input through an exclusive browser from a distant place and makes a controlling signal in the real-time operating portion 80.

After the determined and arbitrary information generating portion (90 & 92) generate information to be embedded as a watermark, the watermark generating portion 94 generates a watermark using such information.

The watermark generated in the watermark generating portion 94 is embedded into a digital image as a robust watermark in real time in the RW embedding portion 40. Since RW can survive the compression, it is possible to embed it before compressing an image.

The robust watermark-embedded digital image is compressed corresponding to each compressing method such as JPEG, Wavelet, and MPEG in the image compressing portion 50 so as to be transmitted through network, and a fragile watermark is embedded into the above compressed digital image signal in real time in the FW embedding portion 60.

When the embedding of a fragile watermark is finished, the image is transmitted to network through the network connecting portion 70, thereby not only the original image for monitoring is provided but also a digital image signal capable of authenticating the original of the provided image and its forgery/alternation is provided.

Next, an apparatus of authenticating a watermark-embedded image which is transmitted from the network camera apparatus 10 and its process are explained. FIG. 2A is a block diagram illustrating the constitution of an apparatus 100 of authenticating the original of an image transmitted through network from the network camera apparatus 10 of FIG. 1 and whether the image is forged/altered or not.

Referring to FIG. 2A, the authenticating apparatus 100 comprises an image inputting portion 110, an image storing portion 120, an image decompressing portion 130, an image authenticating portion 140 comprising RW authenticating portion 142 and FW authenticating portion 144, and an image authenticating result output portion 150, and the authenticating apparatus according to one embodiment of the present invention can be implemented in the Window environment of a personal computer for user's convenience.

In the image inputting portion 110, a watermark-embedded digital image (image to be authenticated) which is transmitted through network from the network camera apparatus 10 of FIG. 1 is input through network in a compressed form.

In the image storing portion 120, the image signal outputted from the image inputting portion 110 is stored in a compressed form. The image decompressing portion 130 decompresses the image signal stored in the image storing portion 120 and restore it to the image signal prior to compression.

The image authenticating portion 140 consists of RW authenticating portion 142 which detects a robust watermark and authenticates the original image and FW authenticating portion 144 which detects a fragile watermark and authenticates the forgery/alteration of the image. The image authenticating portion 140 calculates correlation between the watermark extracted from the restored image signal of the image decompressing portion 130 and a watermark generated from an information for authentication of an image, and decides authentication of the image.

RW authenticating portion 142 calculates correlation between the extracted robust watermark and the robust watermark generated for image authentication, and transmits the result that the image is forged/altered to the image authenticating result output portion 150 if the watermark is modified, or transmits the result that the image is authenticated to the image authenticating result output portion 150 if it is not modified.

FW authenticating portion 144 calculates correlation between the extracted fragile watermark and the fragile watermark generated for image authentication, and detects location where a forgery/alteration has been occurred and transmits it to the image authenticating result output portion 150 if the watermark is modified, or transmits the result that the image is authenticated to the image authenticating result output portion 150 if it is not modified.

The image authenticating result output portion 150 outputs the result of the authentication decision of the RW authenticating portion 142 and FW authenticating portion 144.

The image authenticating result output portion 150, as explained in one embodiment of the present invention, authenticates the original image by detecting a robust watermark in the RW authenticating portion 142 and detects whether the image is forged/altered and the forged/altered location by detecting a fragile watermark in the FW authenticating portion 144 as occasion demands. Further, it authenticates only the original of the image transmitted through network in the RW authenticating portion 142 or only detects whether the image transmitted through network is forged/altered and where the image is forged/altered in the FW authenticating portion 144.

The operation of the authenticating apparatus 100 according to one embodiment of the present invention described above is as follows:

The watermark-embedded image signal in a compressed form received from the image inputting portion 110 through network is stored in the image storing portion 120. When an operator needs watermark authentication for an image, he/she takes out the image from the image storing portion 120 and decompresses it in the image decompressing portion 130 and restores it to the original image signal.

The restored image is determined as the forged/altered image or authenticated image according to whether the watermark is modified or not from correlation between robust watermarks in the RW authenticating portion 142 of the image authenticating portion 140. The FW authenticating portion 144 calculates correlation between fragile watermarks and determines whether the watermark is modified or not from the above correlation result. Hence, the location where the image is forged/altered is detected or the confirmation result that the image is authenticated is transmitted to and outputted in the image result output portion 150, thereby while monitoring the corresponding place, not only the original image for monitoring is provided but also it is authenticated whether the provided image is the original and/or whether the provided image is forged/altered as occasion demands.

Next, referring to FIGS. 2B and 2C, a process of authenticating a robust watermark and a fragile watermark in the image authenticating portion 140 is explained.

A method of extracting a watermark could be the reverse process of embedding a watermark. In case of embedding a key watermark, a process of extracting a watermark is as follows:

First, to be brief, after the same unique key as the key used in embedding said watermark is input, correlation between the watermark (i.e., watermark for authentication) generated from the key and the watermark extracted from the image is calculated. From this process, the image can be authenticated according to its consistency, and the content of the extracted watermark enables to authenticate whether the image is the original. This is in detail explained in Korean Patent Application No. 2000-53755 which was filed in the same applicant as that of the present invention.

A process of extracting a watermark when embedding an image data as a watermark is also similar, which is in detail explained in Korean Patent Application Nos. 1998-37273 and 1998-37274.

A process of extracting a RW is in detail explained in Korean Patent Application Nos. 2000-53755, 1998-37273, and 1998-37274.

The detailed explanation of the FW extraction is also described in Korean Patent Application Nos. 2000-64767.

When it comes to the content of an image authentication process by a watermark extraction, the watermark extraction process is the reverse of the watermark embedding process.

FIG. 2B is a flow chart illustrating a process of extracting a robust watermark from the apparatus 100 of FIG. 2A and authenticating whether the image is forged/altered or not.

An image to be authenticated is inputted (S200) and a robust watermark is extracted from the inputted image (S210). Further, the watermark, such as key generation or unique image, initially embedded is generated using an information for authentication (S220).

Correlation between the watermark generated using information for image authentication and the extracted watermark is calculated in order to determine whether the extracted watermark is modified or not (S230).

It is determined whether the watermark is modified or not according to the above calculated correlation (S240). If the watermark is determined to be modified, the result that the image is forged/altered is outputted (S250), and if not, the result of the image is authenticated is outputted (S260).

Further, the information regarding the authenticated image can be confirmed by the information obtained from the extracted watermark. For example, it means information robustly embedded so as to confirm the date when the image is obtained, information relating to an operator, the obtained place, etc. The RW is a ground for authenticating an image, and the extracted information could be a ground for furnishing certainty to the authentication.

FIG. 2C is a flow chart illustrating a process of extracting a fragile watermark from the apparatus of FIG. 2A and authenticating whether the image is forged/altered or not.

The authenticating process of a fragile watermark of FIG. 2C does not differ from all the process of FIG. 2B. However, since the purpose of the FW lies in confirming whether an image is forged/altered, as a result of extracting a FW (S310), the forged/altered location is found and marked to be visible to the naked eye (S350), thereby going through a process of confirming the forged/altered part.

As seen from the above FIGS. 2B and 2C, regarding the restored image for authentication, correlation between robust watermarks is calculated in the RW authenticating portion 142 of the image authenticating portion 140, and outputs the image is forged/altered if the above watermark is modified, and the image is authenticated if not. Further, the FW authenticating portion 144 calculates correlation between fragile watermarks and thus if there is a modification in the above watermark, the forged/altered location of the above image is detected and outputted and if not, the result that the image is authenticated is outputted.

In other words, if a RW is not detected, the image is primarily determined to be forged and if detected, a step of detecting FW is proceeded. If FW is detected in a good manner, the image is determined to be perfectly authenticated. Even if RW is detected, if a FW is not well detected, the image is determined to be forged/altered.

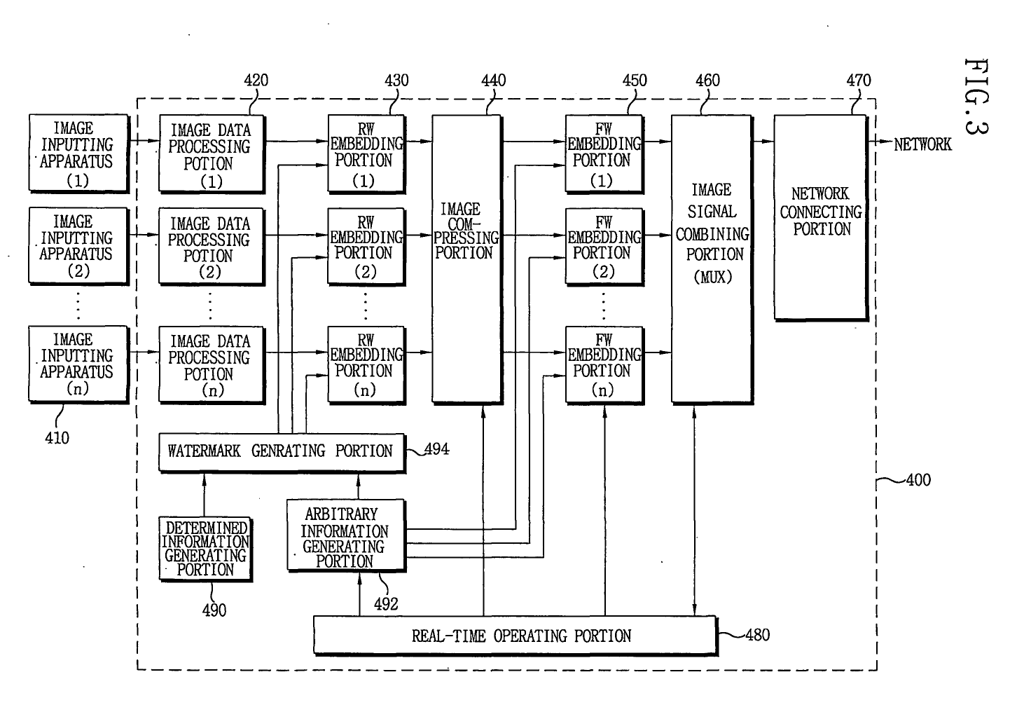

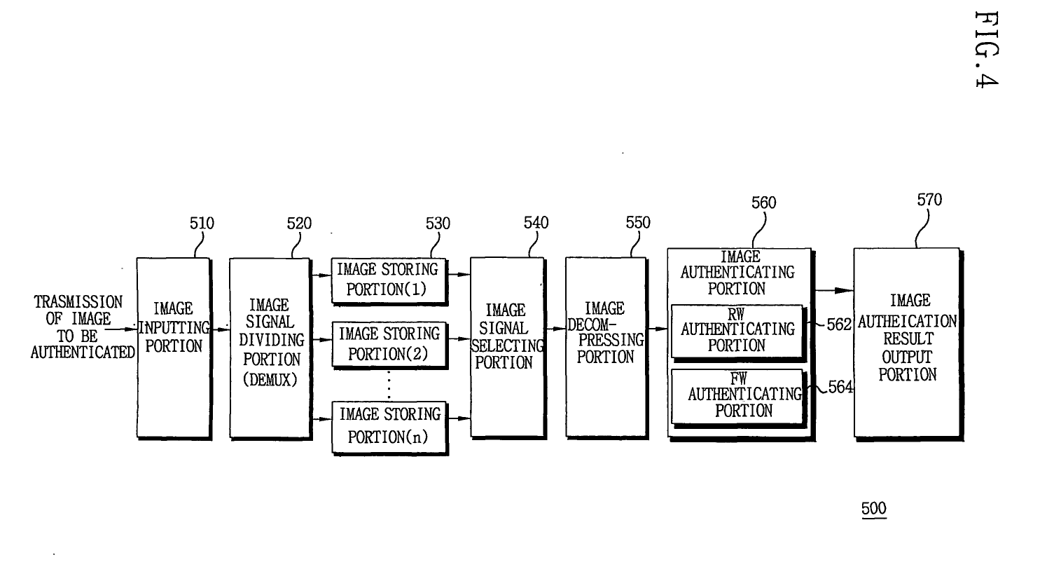

Next, referring to FIGS. 3 and 4, an embodiment wherein a technology of repeatedly embedding a watermark is applied to a network camera server is explained.

FIG. 3 is a block diagram illustrating the constitution of a network camera server 400 which embeds a robust watermark and fragile watermark into a plurality of images outputted from a plurality of image inputting apparatus 410 and transmits it through network according to a second embodiment of the present invention.

Referring to FIG. 3, the network camera server 400 comprises a plurality of image data processing portion 420 each being connected a plurality of image inputting apparatus 410, a determined information generating portion 490, an arbitrary. information generating portion 492, a watermark generating portion 494, a plurality of RW embedding portions 430, a plurality of FW embedding portions 450, an image compressing portion 440, an image signal combining portion (MUX) 460, a network connecting portion 470, and a real-time operating portion 480.

The network camera server 400 according to the second embodiment of the present invention embeds a watermark into a plurality of image signals obtained and inputted from a plurality of image inputting apparatus (410: i.e., external camera) and transmits it through network. Such is almost similar to the technology of embedding a watermark into one image signal inputted from a network camera apparatus 10 and transmitting it through network according to the above first embodiment of the present invention referring to the FIG. 1 in terms of the function and thus its detailed explanation is omitted.

However, in case of the second embodiment, since a plurality of image signals are inputted from a plurality of external camera 410 in real time, the determined and arbitrary information generating portion (490 & 492) generate information to be embedded as a watermark which corresponds to each of said plurality of image signals.

Further, the image signal combining portion (MUX) 460 combines a plurality of digital image signals into one digital image signal in order to more effectively transmit a plurality of digital image signals into which a robust watermark and fragile watermark are repeatedly embedded through network.

The operational process of the network camera server 400 according to the second embodiment of the present invention described above is as follows:

The image signal obtained from several external cameras 410 is inputted into the corresponding image data processing portion 420 using each cable. Since RW should be first embedded into each inputted and digital-converted image signal in real time, a plurality of RW embedding portions (430) each corresponding to a plurality of image data processing portions 420 embed a robust watermark into each of image signals.

After generating necessary information at each determined and arbitrary information generating portion (490 & 492) in order to embed different information regarding each camera as a watermark, the watermark generating portion 494 generates a watermark using an unique information of an individual camera according to the information generated or with arbitrary information as transmitted.

For generating an arbitrary information, if an operator inputs information to be embedded in the image signal photographed by each camera in a distant place through an exclusive browser, the real-time operating portion 480 makes control signal and supplies it for the arbitrary information generating portion 492 and helps with the processing according to the operators' instructions.

The watermark generated by the watermark generating portion 494 is embedded into a digital image in each of the RW embedding portion 430 in an RW-method. Since the inputted image is 10 frames to 30 frames per second, all the watermarks therefor should be processed in real time and such operation is controlled in the real-time operating portion 480.

Each of RW-embedded digital images is compressed corresponding to each compression method of JPEG, Wavelet, MPEG, etc. in the image compressing portion 440 so as to be transmitted over network and then a fragile watermark is embedded into each compressed image in the FW embedding portion 450. For a more effective transmission, a plurality of image signals is combined into one image signal in the image signal combining portion 460 and then transmitted over network through the network connecting portion 470. As such, not only the original image for monitoring is provided while monitoring a plurality of places by one apparatus, but also the originality of the provided image and/or forgery/alteration thereof can be authenticated.

Next, an apparatus of authenticating a watermark-embedded image transmitted from the network camera server 400 and process thereof are explained. FIG. 4 is a block diagram illustrating the constitution of an apparatus 500 of authenticating the originality of an image transmitted through network from a network camera server 400 of FIG. 3 and whether the image is forged/altered or not.

Referring to FIG. 4, the authenticating apparatus 500 comprises an image inputting portion 510 wherein an image to be embedded is input, an image signal dividing portion (DEMUX 520, a plurality of image storing portion 530, an image signal selecting portion 540, an image decompressing portion 550, an image authenticating portion 560 comprising RW authenticating portion 562 and FW authenticating portion 564, and an image authenticating result output portion 570. The authenticating apparatus 500 according to one embodiment of the present invention can be implemented in Window environment of a personal computer for a user's convenience.

A combined image signal which a watermark was embedded and compressed in the network camera server 400 of FIG. 3 is transmitted through network and inputted to the image inputting portion 510.

In the image signal dividing portion 520, the one combined image signal outputted from the image inputting portion 510 is divided into each image signal in the compressed manner. A plurality of the image storing portion 530 store each image signal which is divided from the image signal dividing portion 520 in the compressed manner.

The image signal selecting portion 540 selects a specific image signal requiring authentication among the plurality of compressed image signals which are stored in the image storing portion 530. In the image decompressing portion 550, the image signal selected in the image signal selecting portion 540 among the image signals stored in the image storing portion 530 is decompressed and thus restored to the image signal prior to compression.

The image authenticating portion 560 consists of the RW authenticating portion 562 of detecting a robust watermark and authenticating the originality of the image and the FW authenticating portion 564 of detecting a fragile watermark and authenticating whether the image is forged/altered. Further, the image authenticating portion 560 calculates correlation between the watermark extracted from the restored image signal of the image decompressing portion 550 and the watermark generated from information for image authentication to decide the image authentication.

The RW authenticating portion 562 calculates correlation between the extracted robust watermark and the robust watermark generated from the information for image authentication to transmit the result that the image is forged/altered, if the above watermark is modified, and the result that the image is authenticated, if not, to the image authentication result output portion 570.

The FW authenticating portion 564 calculates correlation between the extracted fragile watermark and the fragile watermark generated from the information for image authentication. If the above watermark is modified, the forged/altered location of the above image is detected and transmitted it to the image authentication result output portion 570 and, if not, a result that the image is authenticated is transmitted to the image authentication result output portion 570.

The image authentication result output portion 570 outputs the result of authentication decision of the RW authenticating portion 562 and the FW authenticating portion 564.

In the same manner as the image authentication portion 140 according to one embodiment of the present invention referring to FIG. 2, the RW authenticating portion 562 detects a robust watermark and authenticates the originality of the image and the FW authenticating portion (564) detects a fragile watermark and authenticates whether the image is forged/altered and finds the forged/altered location, or the RW authenticating portion 562 authenticates only whether the image transmitted through network is original or the FW authenticating portion 564 detects only whether the image transmitted through network is forged/altered and the forged/altered location, as occasion demands.

The operation of the authenticating apparatus 500 according to the second embodiment of the present invention described above is as follows:

The one united digital image signal after each watermark is embedded into a plurality of image signals inputted from a plurality of external cameras 410 is transmitted through network and inputted in the image inputting portion 510. Next, said digital image signal is divided into image signal photographed by a individual camera through the image signal dividing portion (DEMUX) 520 and is stored in each corresponding image storing portion 530. When an operator needs a watermark authentication for the corresponding image, the image is taken out of the corresponding image storing portion 530 using the image signal selecting portion 540 and decompresses the signal in the image decompressing portion 550 and restores it to the original image signal.

The RW authenticating portion 562 of the image authenticating portion 560 calculates correlation between robust watermarks and determines whether the above watermark is modified according to the correlation result and thus outputs the result of the forged/altered image or the authenticated image. Further, according to the determination of whether said watermark is modified from correlation between fragile watermarks in the FW authenticating portion 562, the forged/altered location of the image is detected or the result that the image is authenticated is outputted to the image authentication result output portion 570 and thus displayed. As such, not only the original image for monitoring is provided while monitoring a plurality of places by one apparatus, but also the originality of the provided image and/or forgery/alteration thereof can be authenticated.

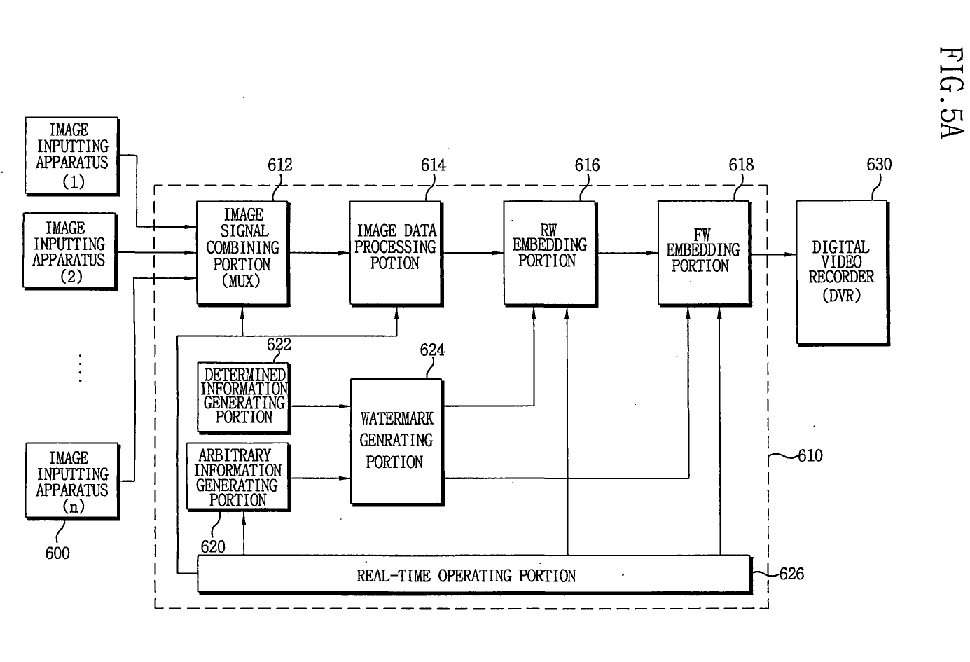

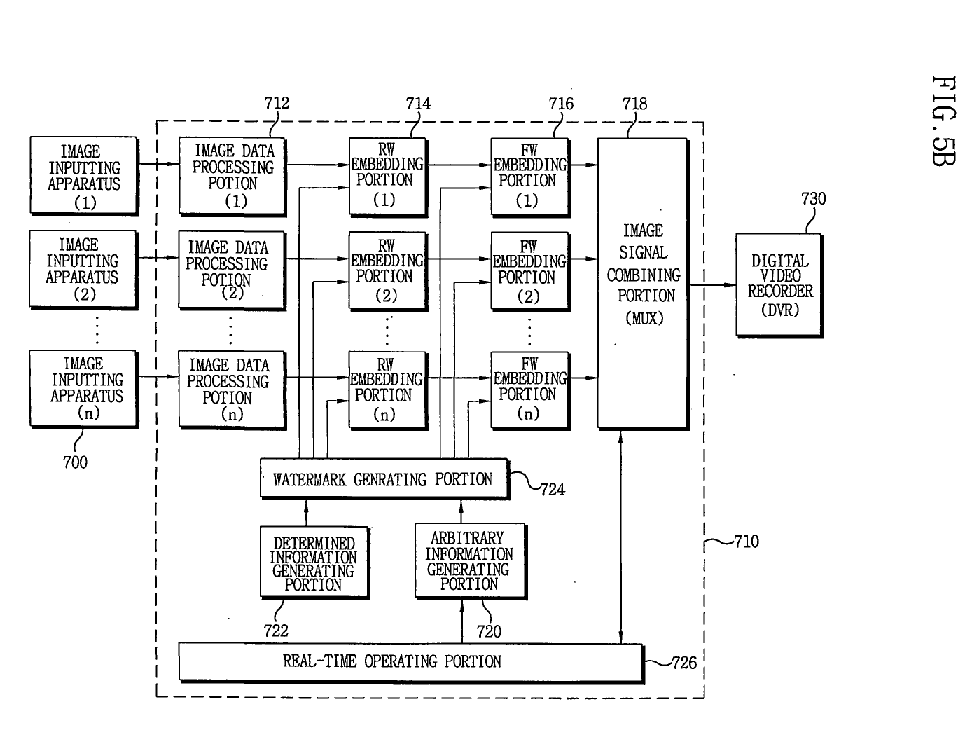

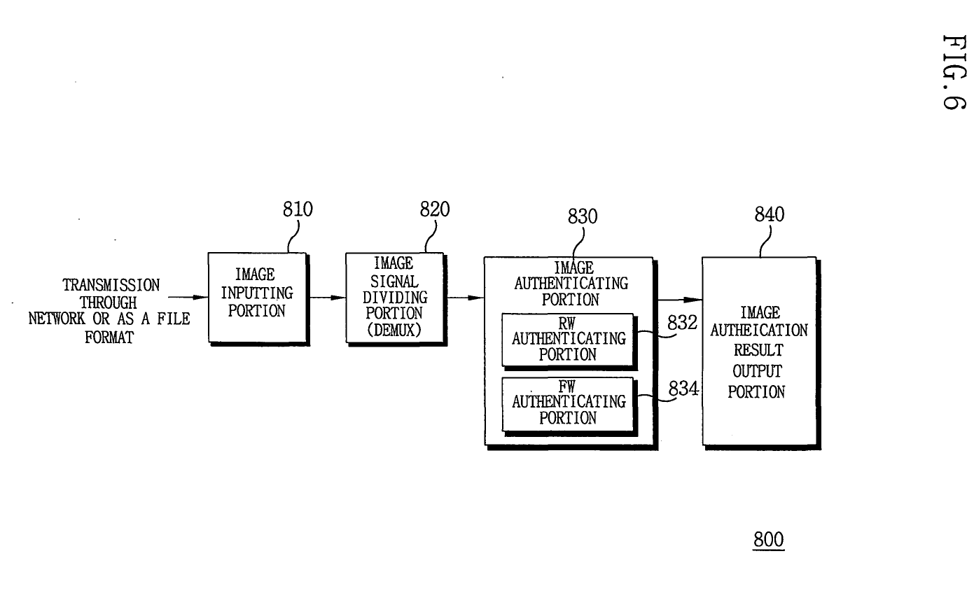

Next, referring to FIGS. 5 and 6, an embodiment wherein a technology of repeatedly embedding watermark according to the present invention is applied to the digital video recorder (DVR) is explained.

FIG. 5A is a block diagram illustrating the constitution of a watermark embedding apparatus 610 which embeds a robust watermark and fragile watermark into a plurality of image inputted from a plurality of image inputting apparatus 600 and a digital video recorder 630 which connected to the watermark embedding apparatus and records and stores a watermark-embedded image according to a third embodiment of the present invention.

The function and process of the internal components of the watermark embedding apparatus 610 illustrated in FIG. 5a are similar to those of the network camera server 400 and thus the similar parts are briefly explained.

Such watermark embedding apparatus 610 is integrated into the existing DVR as hardware or as a software module.

First, the image signal (analog: NTSC, PAL) which is outputted from a plurality of image inputting apparatus (600: i.e., video camera, digital camera, analog camera, etc.) is inputted to the watermark embedding apparatus (610: it could be integrated into the DVR).

The inputted plurality of image signals are connected in the image signal combining portion (MUX) 612 in a time-divisional manner and each image signal is transmitted to the image data processing portion 614 in a time-division in the image signal combining portion 612.

What the watermark embedding apparatus 610 of FIG. 5A differs from the network camera server 400 of FIG. 3 or the watermark embedding apparatus 710 of FIG. 5B which will be explained later is the location of said image signal combining portion 612, i.e, the image signal combining portion 612 of FIG. 5A is located in the front end portion of the apparatus 610.

For the relation of the signal passing through the image signal combining portion 612 and watermark embedding algorithm (i.e., embedding of RW and FW) in the embodiment of FIG. 5A, a watermark corresponding to each individual time-divided inputting signal should be embedded according to the control of the real-time operating portion 626. A fast watermarking embedding algorithm should be implemented for a real-time implementation of such system. However, if a sufficiently small watermark embedding algorithm is obtained and a speed of hardware processor is fast, the embodiment of FIG. 5A is also useful.

Next, the image data processing portion 614 converts the image signal inputted as analog into the digital image signal (i.e., A/D conversion).

The RW watermark and FW watermark generated in the watermark generating portion 624 are embedded into the image signal outputted from the image data processing portion 614. The RW embedding portion 616, which is a portion of embedding a robust watermark, generally embeds data such as copyright information, camera perceiving number, frame order and the like capable of being survived in spite of an external attack.

The FW embedding portion 618 is the portion of embedding information for determining whether the image signal is forged/altered or not. The fragile watermark algorithm employed herein has the characteristics that it is resistant to the compression and other forgery/alteration makes the watermark signal disappear, which results in perceiving the forged/altered part.

To be more specific, it is not necessary for FW to be resistant to the compression since the FW embedding portion is located in the latter part compared with the image compressing portion in the network camera apparatus and network camera server referring to FIGS. 1 and 3. However, since the image compressing portion exists inside the DVR after embedding FW in the embodiment regarding the DVR, it is required that the FW should be embedded in a intensity of being resistant to the compression and being weak against other forgery/alternation attacks.

Differently from the network camera server 400 of FIG. 3, the reason why the image compressing portion is not included in the watermark embedding apparatus 610 in the present embodiment is that differently from the embodiment of FIG. 3, the transmission of an image signal through network is not required and there is a process of compressing an image signal in the DVR 630 in the embodiment regarding the DVR.

The real-time operating portion 626 controls the function of the watermark embedding apparatus 610 so as to embed watermark information. Further, the real-time operating portion 626 controls the image signal combining portion 612 to make a variety of inputting signals to one data sequence and simultaneously performs function of embedding the watermark information suitable for each corresponding image information.

The watermark-embedded image signal is inputted into the digital video recorder (630: DVR) and then recorded and stored therein. Since the signal outputted from the watermark embedding apparatus 610 is one MUX signal, the image signal is inputted as one channel of the DVR 630. The watermark-embedded image which is outputted from the watermark embedding apparatus 610 is stored in a recording medium such as a computer hard disk or DAT in the DVR 630.

The DVR 630 stores an image in a compressed form. When an image signal is converted into a digital, the amount of data becomes large whose effective storage requires a compression algorithm. The compression algorithms usually employed at present are MJPEG, H.263, MPEG4, etc. Hence, the FW which survives said compression algorithms and makes a watermark disappear in other forgery/alteration (image replacement, image form change, etc.) is employed.

FIG. 5B is a block diagram illustrating the constitution of a watermark embedding apparatus which embeds a robust watermark and fragile watermark into a plurality of image inputted from a plurality of image inputting apparatus and a digital video recorder which is connected to said watermark embedding apparatus and records and stores a watermark-embedded image according to a modification of the third embodiment of the present invention.

FIG. 5B is almost similar to the embodiment of FIG. 5A. The differences are that the image signal combining portion 718 is located in the latter stage of the apparatus 710 and each inputted image signal has a separate watermark embedding portion (RW and FW) in the embodiment of FIG. 5B.

The embodiment of FIG. 5B having such constitution is advantageous to real-time implementation of a watermarking algorithm compared with the embodiment of FIG. 5A. The watermark-embedded image signal is transmitted to the digital video recorder 730 and then recorded and stored. The detailed explanation thereof is omitted since it is similar to the embodiment of FIG. 5A except that a separate watermark is embedded into each image signal.

Next, an apparatus of authenticating a watermark-embedded image outputted from DVR 630 of FIG. 5A and DVR 730 of FIG. 5B and process thereof are explained.

FIG. 6 is a block diagram illustrating the constitution of an apparatus (800) of authenticating the original of an image outputted from a digital video recorder and whether the image is forged/altered referring to FIGS. 5a and 5b.

Referring to FIG. 6, the authenticating apparatus 800 includes an image inputting portion 810 wherein a watermark-embedded image signal which is recorded and stored in a DVR is inputted as a transmission through network or a file format, image signal dividing portion (DEMUX) 820, image authenticating portion 830 comprising RW authenticating portion 832 and FW authenticating portion 834, and image authenticating result output portion 840. It is possible for such authenticating portion 800 to have all the constructions integrated into the DVR or connected with DVR through network.

Further, since the image outputted from the DVR is decompressed when the image compressed and stored inside the DVR is outputted towards outside, there is no need to decompress the image in the authenticating apparatus 800 as did in FIGS. 2A and 4.

The image inputting portion 810 can receive the above image as a transmitting means like network or file format for authenticating a watermark-embedded digital image which is stored in the digital video recorder (DVR: 630 or 730).

The image signal dividing portion (DEMUX) 820 performs function of properly dividing a watermark-embedded image signal into each separate camera signal. That is, while several image signals are made into one stream information using MUX in embedding a watermark in FIGS. 5A and 5B, to the contrary a camera image signal to be authenticated is extracted from one stream information using DEMUX to authenticate RW and FW in the authenticating apparatus 800.

The image authenticating portion 830 functions to authenticate RW and FW from the divided image signals and employs the same watermark detection algorithm as that of FIGS. 2 and 4.

The image authentication result output portion 840 outputs information (copyright information, a order of image frame, camera number, etc.) embedded as the RW authentication result and displays the corresponding part in case the inputted image is forged/altered as the FW authentication result.

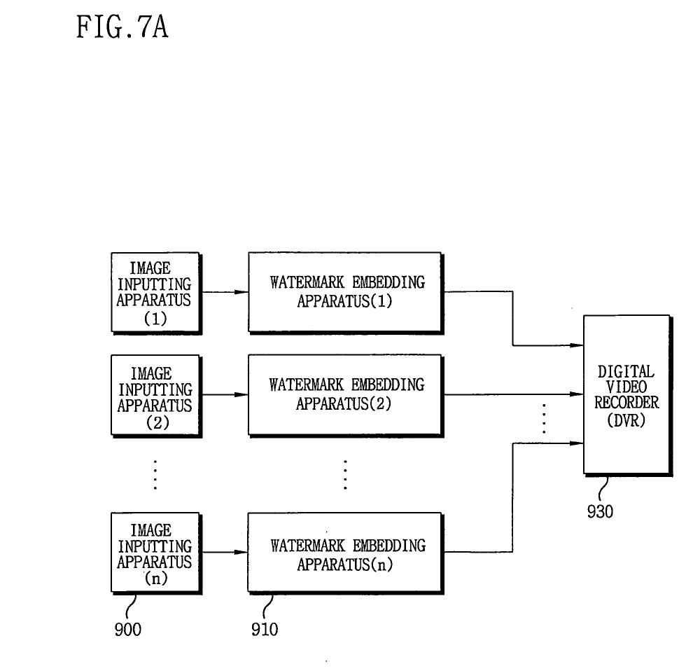

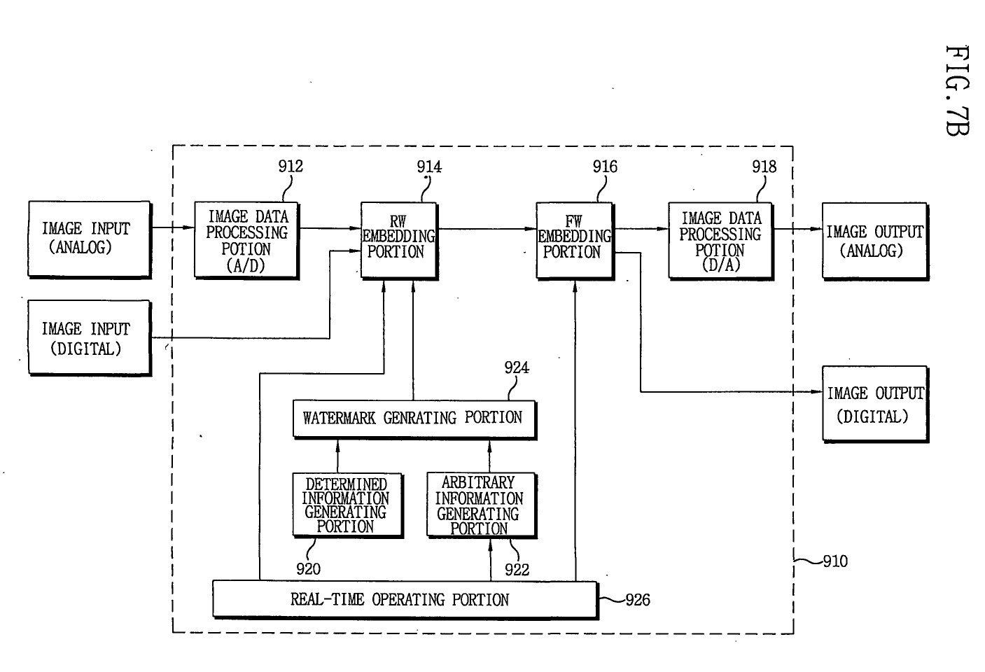

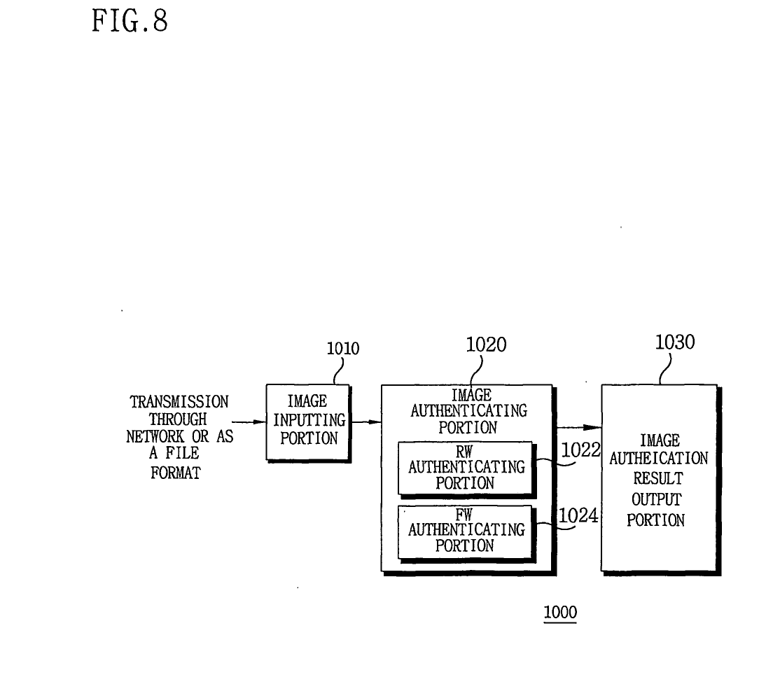

Next, referring to FIGS. 7 and 8, an embodiment of installing a separate watermark embedding apparatus in each image inputting apparatus is explained.

FIG. 7A is a block diagram illustrating the constitution of a watermark embedding apparatus which is separately connected to each of a plurality of image inputting apparatus 900 and a digital video recorder 930 which is connected to said watermark embedding apparatus 910 and records and stores a watermark-embedded image according to a fourth embodiment of the present invention.

What the fourth embodiment referring to FIG. 7A differs from the third embodiment referring to FIGS. 5A and 5B is that in case of the third embodiment, one watermark embedding apparatus is installed at the DVR to embed a watermark into the image signal inputted from a plurality of external cameras, whereas in case of the fourth embodiment, a watermark embedding apparatus is separately installed in each external camera to embed a watermark into the image signal.

Referring to FIG. 7A, the watermark embedding apparatus 910 is separately attached to each of the image inputting apparatus (900: i.e., external camera) parts to embed a watermark and the watermark-embedded image signal is converted to an analog image signal and then outputted using an image conversion apparatus (D/A), if necessary, or outputs a digital image as it is, which is inputted in the digital video recorder (DVR: 930) and then recorded and stored.

Image signal (digital or analog signal) is obtained from multiple image inputting apparatus (900: digital video camera, analog video camera, digital camera, analog camera, etc.). The obtained image signal is inputted in each watermark embedding apparatus 910 and a watermark is embedded therein. The embedded image signal is recorded and stored to the DVR 930. DVR which come into the market at present can receive up to 16 channels to be processed. Hence, in case of implementing a watermarking system like FIG. 7A, the existing DVR system can be used as it is. In other words, the watermark embedding apparatus 910 is installed in the existing installed camera (image inputting apparatus) as hardware or as a software module.

FIG. 7B is a block diagram illustrating a detailed constitution of a watermark embedding apparatus 910 referring to FIG. 7.

The inputting signal of the watermark embedding apparatus 910, which is an analog or digital image signal (NTSC, PAL, etc.), is converted to a digital image signal by the image data processing portion (A/D) 912 in case it is an analog image signal.

The digital image signal passes through the RW embedding portion 914 and FW embedding portion 916, and a watermark is embedded therein.

The image signal outputted from the watermark embedding apparatus 910 can be in the analog or digital form. The image signal outputted in the analog form makes an A/D conversion through the image data processing portion inside the DVR 930. The image signal outputted in the digital form can be employed when the DVR can directly receive and process the digital image signal.

FIG. 8 is a block diagram illustrating the constitution of an apparatus 1000 of authenticating the originality of the image outputted from a digital video recorder 930 of FIG. 7A and whether the image is forged/altered.

The authenticating apparatus 1000 of FIG. 8 is quite similar to the authenticating apparatus 800 of FIG. 6. The only difference is that the image signal dividing portion (DEMUX) does not exist in the authenticating apparatus 1000 of FIG. 8. That is why since the watermark-embedded image signal of FIG. 7 according to the fourth embodiment of the present invention does not combine image signals and are inputted in the DVR as a plurality of channels and then stored using the essential function of the DVR, extraction of the stored image uses only the function of selecting and sending the image of information desired in the DVR from hard disk and does not require a process of combining image signals.

The image outputted from the DVR 930 is transmitted through network or copied to a diskette in a file format to send the image information by an image authenticating apparatus 1000 installed equipment. As such, the image signal inputted in the image inputting portion 1010 determines the forgery/alteration thereof in the image authenticating portion 1020 and displays the result through the image authentication result output portion 1030. The detailed explanation thereof is identical to FIG. 6 and thus omitted.

As such, a method and apparatus of transmitting an image through network after obtaining an image through a network camera and network camera server, embedding a watermark into the obtained image and passing through series of process of preventing the image from forged/altered and authenticating the original image are explained as a preferred embodiments. Further, for another embodiment, a method and apparatus for authenticating the original image and confirming the forgery/alteration after embedding a watermark into the obtained image and storing it in the digital video recorder (DVR). However, the method and apparatus of the present invention can be applied to all the system of obtaining, storing, and transmitting an image.

An independent apparatus (a box type, or chip or chip set type) having such function can be implemented in order to perform the above watermarking procedure. That is, it can perform series processes of embedding a watermark in the above image that is placed within the image transmitting camera and is realized as an apparatus such as an independent box, etc. so as to be installed in the camera exterior or DVR box.

Until now, the above preferred embodiments are disclosed and explained particularly referring to above embodiments. However, it is obvious to a person skilled in the pertinent technical field that such embodiments are merely for examples, which are not restricted thereto, and various modifications and conversion are possible within the scope of the technical idea of the present invention. Accordingly, the technical scope of the present invention shall be limited solely by the scope of the claims appended hereto not by the contents described in the embodiments.

### Industrial Applicability

As described above, a network camera and network server apparatus having a watermark embedding function and a camera and a digital video recorder (DVR) having a watermark embedding function prevent an illegal image operation which could be made on the image photographed for supervision and, simultaneously detect the illegal operation made on the image for supervision, according to the present inventions which authenticate the original image and the forgery/alternation of an image through a process of extracting the embedded watermark.

And they have an authenticating effect of confirming and deciding authenticity of the image of an network camera and camera server having a watermark embedding function and the image photographed and recorded in a storing apparatus. In other words, when it is necessary to authenticate an image, they have effects of not only authenticating an exact operator and image but also finding even the forgery/alternation of an image by simultaneously embedding a robust watermark which has information regarding the operator and image in the image photographed by camera and survives any external attacks and a fragile watermark damaged by a minute external operation or modification. As a representative embodiment, the present invention embeds a robust watermark and a fragile watermark simultaneously, i.e., a watermarking method of perceiving the forgery/alternation of an image, thereby increasing effect of authenticating an image by means of double authentication.

What is claimed is:

1. A network camera apparatus comprising:
an image inputting portion for receiving an image signal photographed in real time;
an image data processing portion for converting the image signal outputted from said image inputting portion to a digital signal;
an information generating portion for generating an information to be embedded as a watermark;
a watermark generating portion for generating the watermark using the information of said information generating portion;
a watermark embedding portion for embedding the watermark generated at said watermark generating portion into the image signal outputted from said image data processing portion;
an image compressing portion for compressing the watermark-embedded image signal outputted from said watermark embedding portion; and
a network connecting portion for transmitting the compressed image signal outputted from said image compressing portion through network.

2. The network camera apparatus according to claim 1,
wherein said information generating portion is a determined information generating portion for generating an information on the basis of the determined information stored in said network camera apparatus, and the watermark which is embedded into the image signal at said watermark embedding portion is a robust watermark.

3. A network camera apparatus comprising:
an image inputting portion for receiving an image signal photographed in real time;
an image data processing portion for converting the image signal outputted from said image inputting portion to a digital signal;
an image compressing portion for compressing the image signal outputted from said image data processing portion;
an information generating portion for generating an information to be embedded as a watermark;
a watermark generating portion for generating the watermark using the information of said information generating portion;
a watermark embedding portion for embedding the watermark generated at said watermark generating portion into the image signal outputted from said image compressing portion; and
a network connecting portion for transmitting the watermark-embedded image signal outputted from said watermark embedding portion through network.

4. The network camera apparatus according to claim 3,
wherein said information generating portion is an arbitrary information generating portion for generating an information transmitted from a distant place through network, and the watermark which is embedded into the image signal at said watermark embedding portion is a fragile watermark.

5. A network camera apparatus comprising:
an image inputting portion for receiving an image signal photographed in real time;
an image data processing portion for converting the image signal outputted from said image inputting portion to a digital signal;
an information generating portion for generating an information to be embedded as a watermark;
a watermark generating portion for generating the watermark using the information of said information generating portion;
a first watermark embedding portion for embedding a first watermark generated at said watermark generating portion into the image signal outputted from said image data processing portion;
an image compressing portion for compressing the first watermark-embedded image signal outputted from said first watermark embedding portion;
a second watermark embedding portion for embedding a second watermark generated at said watermark generating portion into the compressed image signal outputted from said image compressing portion; and
a network connecting portion for transmitting the second watermark-embedded image signal outputted from said second watermark embedding portion through network.

6. The network camera apparatus according to claim 5,
wherein said information generating portion comprises a determined information generating portion for generating an information on the basis of the determined information stored in said network camera apparatus; and an arbitrary information generating portion for generating an information transmitted from a distant place through network, and
the first watermark which is embedded into the image signal at said first watermark embedding portion is a robust watermark, and the second watermark which is embedded into the image signal at said second watermark embedding portion is a fragile watermark.

7. The network camera apparatus according to any one of claims 1 to 6, further comprising a real-time operating portion for controlling said embedding of the watermark, said compressing of the image signal, and said generating of the arbitrary information in real time.

8. An apparatus for authenticating a watermark-embedded image transmitted from the network camera apparatus described in any one of claims 1 to 6,
an image inputting portion receiving a watermark-embedded and compressed image signal through network;
an image decompressing portion for restoring the image signal outputted from said image inputting portion to the image signal prior to compression;
an, image authenticating portion for determining authenticity of the image by calculating correlation between a watermark extracted from the digital image which is restored at said image decompressing portion and a watermark generated from an information for authentication of an image; and
an image authentication result output portion for outputting an authentication result of said image authenticating portion.

9. The apparatus according to claim 8, wherein said image authenticating portion comprises:
a robust watermark authenticating portion for detecting a robust watermark, thereby determining whether the image is the original; and
a fragile watermark authenticating portion for detecting a fragile watermark, thereby determining whether the image has been forged/altered and finding the location where a forgery/alteration has been occurred.

10. A method for embedding a watermark into an image signal photographed through network camera apparatus and transmitting the image signal to a network, said method comprising the steps of:
converting an image signal inputted in real time to a digital signal;
embedding a robust watermark containing a unique information of the network camera apparatus into the converted image signal;
compressing the robust watermark-embedded image signal;
embedding a fragile watermark containing an arbitrary information transmitted from a distant place through network into the compressed image signal; and
transmitting the watermark-embedded image signal through network.

11. A network camera server comprising:
a plurality of image data processing portions for converting each of image signals inputted from a plurality of cameras in real time to a digital signal;
an information generating portion for generating an information to be embedded as a watermark, said information corresponding to each of image signals;
a watermark generating portion for generating each of watermarks corresponding to each of the image signals using the information of said information generating portion;
a plurality of watermark embedding portions for embedding respectively the watermark generated at said watermark generating portion into each of image signals outputted from said plurality of image data processing portions;
an image compressing portion for compressing respectively the watermark-embedded image signals outputted from said plurality of watermark embedding portions;
an image signal combining portion for combining the plurality of image signals outputted from said image compressing portion into a single image signal; and
a network connecting portion for transmitting the combined image signal outputted from said image signal combining portion through network.

12. The network camera server according to claim 11,
wherein said information generating portion is a determined information generating portion for generating a unique information of said plurality of cameras or said network camera server, and the watermark which is respectively embedded into said plurality of image signals at said plurality of watermark embedding portions is a robust watermark.

13. A network camera server comprising:
a plurality of image data processing portions for converting each of image signals inputted from a plurality of cameras in real time to a digital signal;
an image compressing portion for compressing respectively the image signals outputted from said plurality of image data processing portions;
an information generating portion for generating an information to be embedded as a watermark, said information corresponding to each of image signals;
a watermark generating portion for generating each of watermarks corresponding to each of the image signals using the information of said information generating portion;
a plurality of watermark embedding portions for embedding respectively the watermark generated at said watermark generating portion into each of image signals outputted from said image compressing portions;
an image signal combining portion for combining the plurality of watermark-embedded image signals outputted from said plurality of watermark embedding portions into a single image signal; and
a network connecting portion for transmitting the combined image signal outputted from said image signal combining portion through network.

14. The network camera server according to claim 13,
wherein said information generating portion is an arbitrary information generating portion for generating an information transmitted from a distant place through network, and the watermark which is respectively embedded into said plurality of image signals at said watermark embedding portion is a fragile watermark.

15. A network camera server comprising:
a plurality of image data processing portions for converting each of image signals inputted from a plurality of cameras in real time to a digital signal;
an information generating portion for generating an information to be embedded as a watermark, said information corresponding to each of image signals;
a watermark generating portion for generating each of watermarks corresponding to each of the image signals using the information of said information generating portion;
a plurality of a first watermark embedding portions for embedding respectively a first watermark generated at said watermark generating portion into each of image signals outputted from said plurality of image data processing portions;
an image compressing portion for compressing respectively the watermark-embedded image signals outputted from said plurality of first watermark embedding portions;
a plurality of a second watermark embedding portions for embedding respectively a second watermark generated at said watermark generating portion into each of image signals outputted from said image compressing portion;
an image signal combining portion for combining the plurality of watermark-embedded image signals outputted from said plurality of second watermark embedding portions into a single image signal; and
a network connecting portion for transmitting the combined image signal outputted from said image signal combining portion through network.

16. The network camera server according to claim 15,
wherein said information generating portion comprises a determined information generating portion for generating a unique information of said plurality of cameras or said network camera server; and an arbitrary information generating portion for generating an information transmitted from a distant place through network, and
the first watermark which is respectively embedded into said plurality of image signals at said plurality of first watermark embedding portions is a robust watermark, and the second watermark which is respectively embedded into said plurality of image signals at said second watermark embedding portion is a fragile watermark.

17. The network camera server according to any one of claims 11 to 16, further comprising a real-time operating portion for controlling said embedding of the watermark, said compressing of the image signal, and said generating of the arbitrary information in real time.

18. An apparatus for authenticating a watermark-embedded image transmitted from the network camera server described in any one of claims 11 to 16,
an image inputting portion for receiving a watermark-embedded, compressed and combined image signal through network;
an image signal dividing portion for dividing the combined image signal outputted from said image inputting portion into an image signal corresponding to each of cameras;
a plurality of image storing portion for storing respectively the image signal divided at said image signal dividing portion;
an image signal selecting portion for selecting a image signal which needs to be authenticated among the image signals stored in said image storing portions;
an image decompressing portion for restoring the image signal selected at said image signal selecting portion to the image signal prior to compression;
an image authenticating portion for determining authenticity of the image by calculating correlation between a watermark extracted from the digital image which is restored at said image decompressing portion and a watermark generated from an information for authentication of an image; and
an image authentication result output portion for outputting a authentication result of said image authenticating portion.

19. The apparatus according to claim 18, wherein said image authenticating portion comprises:
a robust watermark authenticating portion for detecting a robust watermark, thereby determining whether the image is the original; and
a fragile watermark authenticating portion for detecting a fragile watermark, thereby determining whether the image has been forged/altered and finding the location where a forgery/alteration has been occurred.

20. A method for embedding watermark into a plurality of image signals inputted from a plurality of cameras and transmitting the image signals to a network, said method comprising the steps of:
converting said plurality of image signals inputted from said plurality of cameras in real time to digital signals;
embedding a robust watermark containing a unique information of the plurality of cameras or the network camera server into each of the converted image signals in real time;
compressing the robust watermark-embedded image signals respectively;
embedding a fragile watermark containing an arbitrary information transmitted through network into each of the compressed image signals in real time;
combining the plurality of the fragile watermark-embedded image signals into a single image signal; and
transmitting the combined image signal through network.

21. A digital video recorder which comprises a watermark embedding apparatus for embedding watermark into a plurality of image signals inputted from a plurality of cameras, said watermark embedding apparatus comprising:
a plurality of image data processing portions for converting each of image signals inputted from a plurality of cameras in real time to a digital signal;
an information generating portion for generating an information to be embedded as a watermark, said information corresponding to each of image signals;
a watermark generating portion for generating each of watermarks corresponding to each of the image signals using the information of said information generating portion;
a plurality of a first watermark embedding portions for embedding respectively a first watermark generated at said watermark generating portion into each of image signals outputted from said plurality of image data processing portions; and
an image signal combining portion for combining the plurality of watermark-embedded image signals outputted from said plurality of the first watermark embedding portion into a single image signal,
wherein the image signal outputted from said image compressing portion is compressed and then recorded.

22. The digital video recorder according to claim 21, wherein said watermark embedding apparatus further comprises a plurality of a second watermark embedding portions for embedding respectively a second watermark generated at said watermark generating portion into each of image signals outputted from said plurality of the first watermark embedding portion.

23. The digital video recorder according to claim 22,
wherein said information generating portion comprises a determined information generating portion for generating a unique information of each of said plurality of cameras; and an arbitrary information generating portion for generating an information transmitted from a distant place through network, and
the first watermark which is respectively embedded into said plurality of image signals at said plurality of the first watermark embedding portions is a robust watermark, and the second watermark which is respectively embedded into said plurality of image signals at said second watermark embedding portion is a fragile watermark.

24. The digital video recorder according to any one of claims 21 to 23, wherein said watermark embedding apparatus further comprises a real-time operating portion for controlling said embedding of the watermark and said generating of the arbitrary information in real time.

25. The digital video recorder according to any one of claims 21 to 23, wherein said watermark embedding apparatus is integrated into said digital video recorder as a hardware or as a software module.

26. An apparatus for authenticating a watermark-embedded image from the digital video recorder described in any one of claims 21 to 23,
an image inputting portion for receiving a watermark-embedded and combined image signal as a transmission through a network or a file format;
an image signal dividing portion for dividing the combined image signal outputted from said image inputting portion into an image signal corresponding to each of cameras;
an image authenticating portion for determining authenticity of the image by calculating correlation between a watermark extracted from the digital image from said image signal dividing portion and a watermark generated from an information for authentication of an image; and
an image authentication result output portion for outputting a authentication result of said image authenticating portion.

27. A method for embedding a watermark into a plurality of image signals inputted from a plurality of cameras and recording the image signals, said method comprising the steps of:
converting said plurality of image signals inputted from said plurality of cameras in real time to digital signals;
embedding a robust watermark containing a unique information of the plurality of cameras into each of the converted image signals in real time;
embedding a fragile watermark containing an arbitrary information transmitted through network into each of the robust watermark-embedded image signals in real time;
combining the plurality of the fragile watermark-embedded image signals into a single image signal; and
compressing the combined image signal and then recording the image signal.

28. A digital video recorder for recording a plurality of image signals inputted from a plurality of cameras,
wherein a plurality of watermark embedding apparatus are respectively installed in said plurality of cameras in a separate manner, and
each of the watermark embedding apparatus comprises:
an image data processing portion for converting the image signal inputted from corresponding camera in real time to a digital signal;
an information generating portion for generating information to be embedded as a watermark;
a watermark generating portion for generating the watermark using the information of said information generating portion; and
a first watermark embedding portion for embedding a first watermark generated at said watermark generating portion into the image signal outputted from said image data processing portion,
wherein the image signal outputted from said first watermark embedding portion is compressed and then recorded.

29. The digital video recorder according to claim 28, wherein each of the watermark embedding apparatus further comprises a second watermark embedding portion for embedding a second watermark generated at said watermark generating portion into the image signal outputted from said first watermark embedding portion.

30. The digital video recorder according to claim 29,
wherein said information generating portion comprises a determined information generating portion for generating an unique information of said corresponding camera; and an arbitrary information generating portion for generating an information transmitted from a distant place through network, and
the first watermark which is embedded into the image signal at said first watermark embedding portion is a robust watermark, and the second watermark which is embedded into the image signal at said second watermark embedding portion is a fragile watermark.

31. The digital video recorder according to any one of claims 28 to 30, wherein each of the watermark embedding apparatus further comprises a real-time operating portion for controlling said embedding of the watermark and said generating of the arbitrary information in real time.

32. An apparatus for authenticating a watermark-embedded image from the digital video recorder described in any one of claims 28 to 30,
an image inputting portion for receiving an image signal as a transmission through a network or a file format;
an image authenticating portion for determining authenticity of the image by calculating correlation between a watermark extracted from the digital image outputted from said image inputting portion and a watermark generated from an information for authentication of an image; and
an image authentication result output portion for outputting a authentication result of said image authenticating portion.
